(19) United States
(12) Patent Application Publication
(10) Pub. No.: US 2015/0003681 A1
(43) Pub. Date: Jan. 1, 2015

(54) IMAGE PROCESSING APPARATUS AND IMAGE PROCESSING METHOD

(71) Applicant: CANON KABUSHIKI KAISHA, Tokyo (JP)

(72) Inventors: Hiroyasu Kunieda, Yokohama-shi (JP); Kiyoshi Umeda, Kawasaki-shi (JP); Wakako Tanaka, Inagi-shi (JP)

(21) Appl. No.: 14/314,951

(22) Filed: Jun. 25, 2014

(30) Foreign Application Priority Data
Jun. 28, 2013 (JP) 2013-137044

(51) Int. Cl. G06K 9/00; G06T 7/00

(52) U.S. Cl. CPC G06K 9/00228; G06T 7/004
USPC 382/103

(57) ABSTRACT

An apparatus includes an obtaining unit, a setting unit, and an image processing unit. The obtaining unit obtains information representing a face direction in a face region of an image that includes a face. The setting unit sets a processing region for executing imaging processing on the image based on the information representing the face direction obtained by the obtaining unit. The image processing unit performs image processing on the processing region set by the setting unit.

### BACKGROUND OF THE INVENTION

1. Field of the Invention

The present invention is related to an image processing apparatus configured to perform image processing on a predetermined region and an image processing method thereof.

2. Description of the Related Art

Image processing methods to automatically detect specific subject patterns from images are used in face recognition, for example. Such image processing methods can be used in many fields such as teleconferencing, man-machine interfaces, security, monitoring systems that track faces, and image compression.

A method using several significant features and the inherent geometric positional relationship between them is a well-known example of an image processing method to detect faces from images. Another example includes a method to detect human faces by using symmetrical features of the human face, color features of the human face, template matching, or a neural network. According to the related art, the detectable directional direction to the face was from the front to a slight diagonal angle, but with recent advancements in technology, it has become possible to detect from the front all the way to the side of the face.

According to the related art, well-known image processing techniques include cosmetic skin correction, red-eye correction, mole removal, trimming, and so on of objects automatically detected within an image. Japanese Patent Laid-Open No. 2008-225720 discloses an image trimming device configured to set a trimming region that includes a face from an image with faces included, in which the central position of the face is detected on the basis of a detection result by a face detection unit, and the trimming region using this central position as the center.

However, according to the trimming device disclosed in Japanese Patent Laid-Open No. 2008-225720, the setting of the trimming region sometimes could not set the processing region of faces properly, which could lead to decreases in quality of the image processing result.

### SUMMARY OF THE INVENTION

One aspect of the present invention is the provision of an image processing apparatus and image processing method that resolves the previously described problem. Another aspect is the provision of an image processing apparatus that can properly set a processing region of images and obtain a high quality image processing result and an image processing method thereof. In an example, information representing a face direction in a face region of an image is obtained. A processing region for executing image processing on the image is set on the basis of the obtained information representing the face direction, and image processing is performed on the set region.

According to an aspect of the present invention, an apparatus includes an obtaining unit configured to obtain information representing a face direction in a face region of an image that includes a face, a setting unit configured to set a processing region for executing imaging processing on the image based on the information representing the face direction obtained by the obtaining unit, and an image processing unit configured to perform image processing on the processing region set by the setting unit.

Further features of the present invention will become apparent from the following description of exemplary embodiments with reference to the attached drawings.

### BRIEF DESCRIPTION OF THE DRAWINGS

FIG. 1 is a diagram illustrating a hardware configuration of an information processing device related to a First Embodiment.

FIGS. 2A and 2B are block diagrams illustrating a software configuration related to the First Embodiment.

FIGS. 3A and 3B is an explanatory diagram regarding the determination of the direction of the face and a block diagrams illustrating an image analysis region setting unit, respectively.

FIGS. 4A and 4B is an explanatory diagram regarding the setting of a face region and a block diagram illustrating an image processing execution unit, respectively.

FIGS. 5A and 5B are diagrams illustrating a process flow for image processing and a process flow when setting a face region.

FIG. 6 is a diagram illustrating a process flow for an automatic layout.

FIG. 7A through 7C are block diagrams illustrating an example configuration of an image processing unit related to a Second Embodiment and a block diagram illustrating an example configuration of an automatic layout device.

FIG. 8A through 8C is a block diagram illustrating an image processing region setting unit related to the Second Embodiment and explanatory diagrams regarding the image processing region setting unit.

FIG. 9 is an explanatory diagram regarding the setting of a smoothing region related to the Second Embodiment.

FIG. 10 is a diagram illustrating a process flow executed by the image processing unit related to the Second Embodiment.

FIG. 11 is a diagram illustrating a process flow executed by a face direction determination unit related to the Second Embodiment.

FIGS. 12A and 12B are process flows executed by the image processing unit according to the Second Embodiment.

FIG. 13 is a block diagram illustrating an example configuration of the image processing unit according to a Third Embodiment.

FIG. 14 is a diagram illustrating a process flow executed by the image processing unit related to the Third Embodiment.

### DESCRIPTION OF THE EMBODIMENTS

### First Embodiment

Hereafter, the embodiments of the present invention for executing image processing of a region with regard to the direction of the detected object will be described. These embodiments only serve as one implementation example of the present invention. The present invention is not limited to these embodiments.

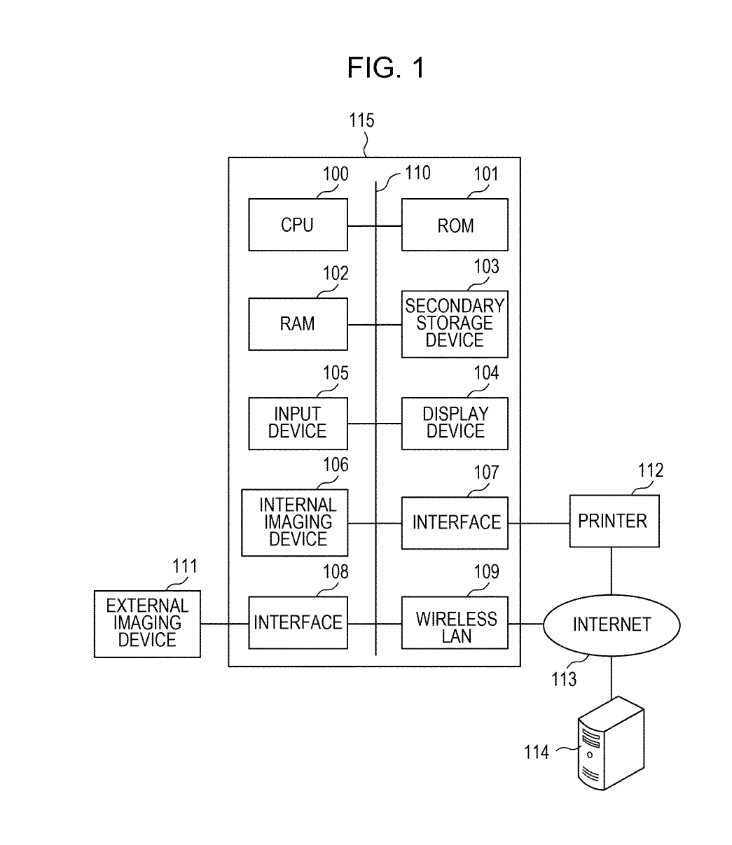

FIG. 1 is a block diagram describing a hardware configuration of an information processing device related to the First Embodiment.

In FIG. 1, an image processing apparatus 115 is provisioned with a central processing unit (CPU) 100, read only memory (ROM) 101, random access memory (RAM) 102, a secondary storage device 103, a display device 104, an input device 105, an interface 107, an interface 108, a wireless local area network (LAN) 109, and an internal imaging device 106. These components are interconnected by a control bus/data bus 110. The image processing apparatus 115 is a computer, for example.

The CPU 100 executes the image processing method according to the present embodiment in accordance with a program.

The ROM 101 stores programs such as applications described later that are executed by the CPU 100. The RAM 102 supplies memory for temporarily storing various types of image information when the CPU 100 executes the program. The secondary storage device 103 is a hard disk functioning as a storage medium to store a database and so on of image files and image analysis results. The CPU 100 loads the programs stored in the ROM 101, secondary storage device 103, etc. into the RAM 102, and executes the loaded programs to perform overall control of the information processing device.

The display device 104 is a display, for example, functioning as a device to present the user with the processing result of the present embodiment and a user interface (UI) described later. The display device 104 can also be provisioned with a touch panel function. The input device 105 is a mouse or keyboard to enable the user to input image correction processing instructions and so on.

Images imaged by the internal imaging device 106 are stored in the secondary storage device 103 after receiving predetermined image processing. The image processing apparatus 115 can also read image data from an external imaging device 111 connected via an interface (the interface 108). The wireless LAN 109 is connected to the Internet 113. The image processing apparatus 115 can obtain image data from an external server 114 over the Internet 113.

A printer 112 for outputting images and so on is connected to the image processing apparatus 115 via the interface 107. The printer 112 is also connected to the Internet, and so can exchange print data via the wireless LAN 109.

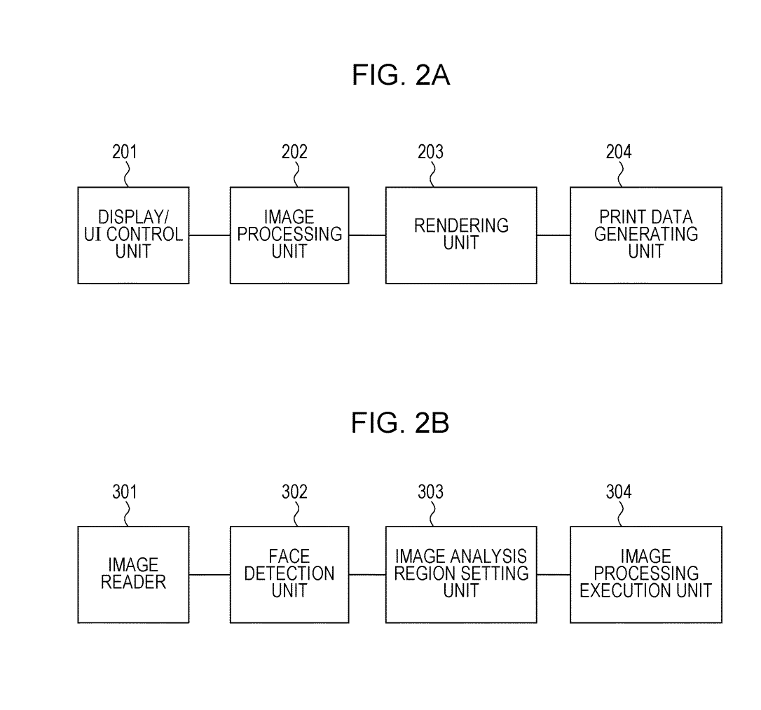

FIG. 2A is a block diagram of a software configuration of the previously described application according to the present embodiment, including a display/UI control unit 201, an image processing unit 202, a rendering unit 203, and a print data generating unit 204.

Bitmap data is input into the image processing unit 202 (application), where image processing which will be described later is performed.

Regarding the generated image processing result, the rendering unit 203 generates the bitmap data, the bitmap data is sent to the display/UI control unit 201, and the result is displayed on the display.

The rendering result is sent to the printer data generating unit 204 (application), where it is converted into printer command data and sent to the printer.

Hereinafter, the basic processing performed in the image processing unit 202 will be described.

FIG. 2B is a block diagram illustrating an example configuration of the image processing unit 202 according to the present embodiment. According to the present embodiment, the image processing unit 202 arranges regions including faces so that they are not removed during automatic layout after setting an image to a specified template. The image processing unit 202 is described using an example in which it arranges regions including faces so as not to be removed, but the present invention is not limited thusly. This example (defined as lack of face region determination) will be described.

As illustrated in FIG. 2B, the image processing unit 202 is provisioned with an object detecting unit 302, an image analysis region setting unit 303, and an image processing execution unit 304.

An image reader 301 loads image data from the hard disk to RAM. Image data is not particularly limited, but here the example used for the description is an RGB image. First, image data obtained by hardware is compressed into a format such as a normal Joint Photography Expert Group (JPEG) image. For this reason, the image reader 301 decompresses the compressed format and converts this into sequential RGB bitmap data. The converted bitmap data is transferred to the display/UI control unit 201 and displayed on the display device 104 or other display.

The object detecting unit 302 detects objects in the image data loaded to RAM. This description presumes that faces are the objects detected.

The object detecting unit 302 divides the image into multiple analysis regions, and detects faces in each analysis region. By setting a portion of each analysis region to overlap with other analysis regions, faces present in small areas of an adjacent analysis region can be reliably detected.

The method performed by the object detecting unit 302 to detect faces is not particularly limited. The face detection method can be the AdaBoost method, for example. AdaBoost is way to implement one strong classifier by serially connecting many weak classifiers together. AdaBoost is a well-known method for serially connecting all weak classifier, but according to the present embodiment, the weak classifier are not connected serially, but branch out in interim depending on the direction of the detected object, and more weak classifier are connected after this branching. After branching out, characteristics of weak classifier are separated depending on the different object directions. That is to say, at least one weak classifier before branching performs determinations based on a standard corresponding to all object directions, and at least one weak classifier after branching in accordance with the object direction performs determination based on a standard corresponding to the object direction. As a result and according to the present embodiment, the face region and the direction of the face can be determined by the object detecting unit 302.

According to the present embodiment, a reliability is calculated regarding each weak classifier depending on the determination result. Specifically, if the value calculated by the weak classifier is determined to be at least a threshold Th1 (hereinafter, also referred to as the calculated threshold) corresponding to the calculated value set by the weak classifier, a previously set value is added to a score to calculate the reliability. Conversely, if the value calculated by the weak classifier is less than the calculated threshold Th1 set by the weak classifier, the previously set value is subtracted from the score to calculate the reliability. For the next weak classifier, the set value for the weak classifier is similarly either added to or subtracted from the score (reliability calculated by the previous weak classifier) depending on the determination result. The calculated threshold Th1 may be set differently for each weak classifier, or may be set to the same value for all weak classifier. In addition, a threshold Th2 (hereinafter, also referred to as score threshold) corresponding to the score is set for each weak classifier. Processing stops if the calculated reliability is at or less than the score threshold Th2. As a result, processing can be skipped for weak classifiers that continue later, which enables processing to be executed quickly. The score threshold Th2 may be set differently for each weak classifier, or may be set to the same value for all weak classifier. When the reliability is calculated for the last of the previously prepared weak classifier, this analysis region is determined as a face. When multiple branches are candidates, the highest reliability calculated from the last weak classifier is designated as the direction of the face.

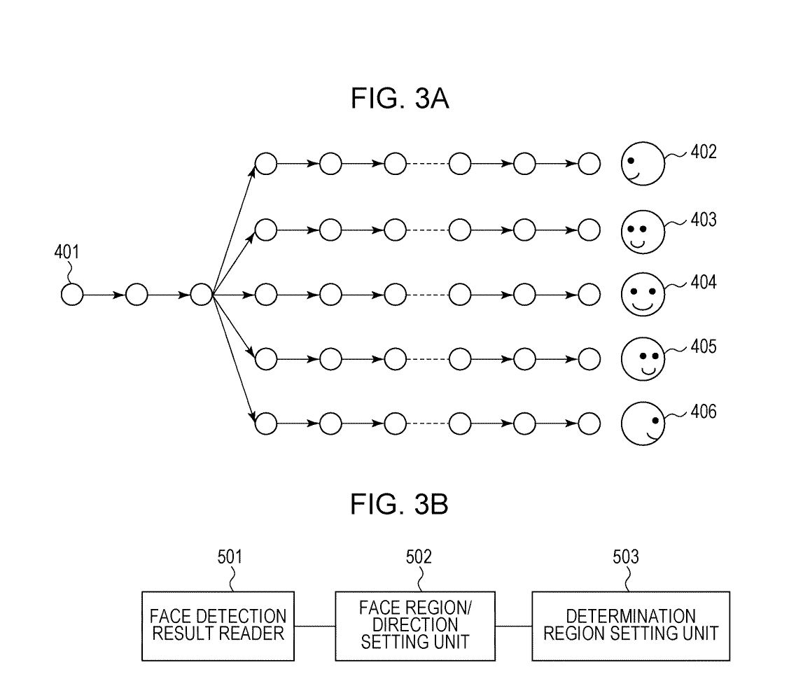

FIG. 3A is an conceptual diagram of a branched structure AdaBoost configuration. Here, the example describes a branch structure classifying into 5 types of face directions, but the number of classifications is not limited thusly.

As illustrated in FIG. 3A, multiple weak classifiers 401 are serially connected, branch out in the interim depending on the direction of the face, and continue on connected serially.

Reference numeral 402 represents a series of weak classifiers weak classifiers for detecting the side of faces having a left direction, and multiple weak classifiers for detecting left directions of faces are serially connected. The region that passes through all weak classifiers for left direction provisioned to the weak classifier series 402 is determined as the left direction face region. Reference numeral 403 represents a series of weak classifiers for detecting angled faces having a left direction, and multiple weak classifiers for detecting left-angle directions of faces are serially connected. The region that passes through all weak classifiers for left-angle direction provisioned to the weak classifier series 403 is determined as the left-angle direction face region. Reference numeral 404 represents a series of weak classifiers for detecting the faces directed to the front, and multiple weak classifier for detecting front faces are serially connected. The region that passes through all weak classifiers for faces directed to the front provisioned to the weak classifier series 404 is determined as the face directed to the front region. Reference numeral 405 represents a series of weak classifiers for detecting angled faces having a right direction, and multiple weak classifiers for detecting right-angle directions of faces are serially connected. The region that passes through all weak classifiers for right-angle direction provisioned to the weak classifier series 405 is determined as the right-angle direction face region. Reference numeral 406 represents a series of weak classifiers for detecting the side of faces having a right direction, and multiple weak classifiers for detecting right-angle directions of faces are serially connected. The region that passes through all weak classifiers for right direction provisioned to the weak classifier series 406 is determined as the right direction face region.

Here, the classifications of face directions illustrated in FIG. 3A will be described. The classification of face directions is set when designing the weak classifier. The classification of face directions can be set in the weak classifier, for example, on the basis of a result obtained from previously obtained face detection patterns from multiple sample images. The classification of face directions is not limited thusly. Classifications can be based on user preferences, information related to the camera position regarding the subject, or from the positional relationship between organs.

Hereafter, the degree of face direction with the face directed to the front as a reference will be referred to as the degree of side direction. When the face direction for the face region is determined on the basis of the position of eyes as the face organs, and only one eye is detected, this is determined as a side direction. When the face direction is determined on the basis of such a method, the face cannot be detected if the eyes cannot be detected. According to the present embodiment, the maximum degree of side direction is designated as when the face is oriented completely to the side, that is to say, when the direction of the face is 90 degrees to the front, but the maximum value of the degree of side direction is not limited thusly. Conversely, as the face direction becomes closer to a face directed to the front, the degree of side direction decreases. The image analysis region setting unit 303 sets the image analysis region used when executing imaging processing on the basis of the detection face region and face direction.

FIG. 3B is a block diagram illustrating an example configuration of the image analysis region setting unit 303. The image analysis region setting unit 303 according to the present embodiment sets region in accordance with the content of image processing as well as the face direction of the detected object.

The image processing example of executing automatic layout will be described. When performing automatic layout, there is a method to create the layout with regions for setting images to specified templates, in which the image is set to these regions. In this case, trimming must be performed if the size of the region for setting the image is different from the size of the image. According to the present embodiment, region setting is performed with consideration to face direction when determining lack of face region.

As illustrated in FIG. 3B, the image analysis region setting unit 303 according to the present embodiment is provisioned with a face detection result reader 501, a face region/direction setting unit 502, and a determination region setting unit 503.

The face detection result reader 501 reads all face regions and directions detected from image regions by the face detection unit 302. The face region/direction setting unit 502 sets one face region and face direction from all read faces for processing.

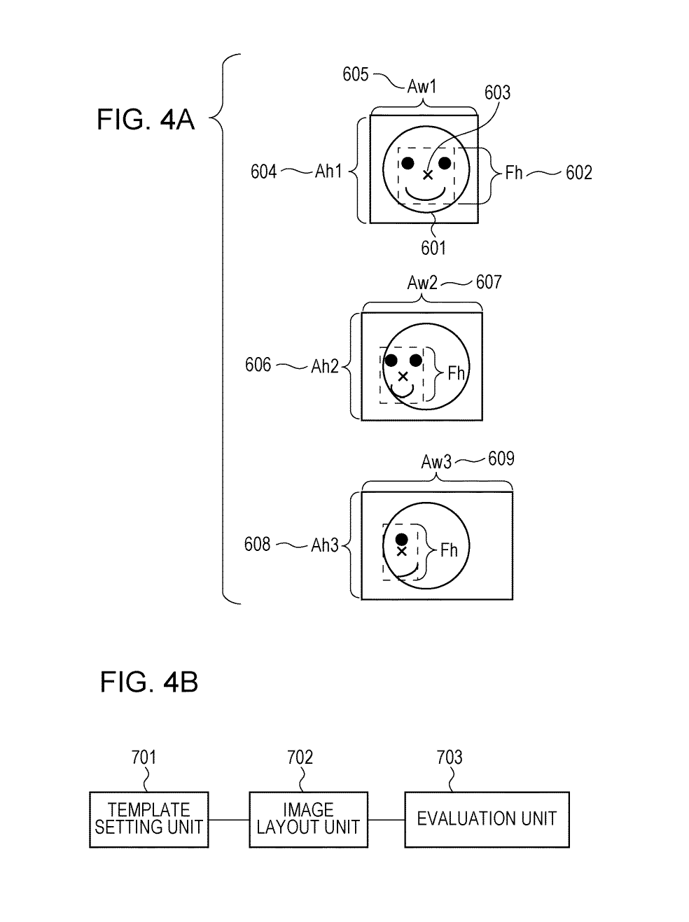

The determination region setting unit 503 sets the determination region used when determining lack of face region based on face directions. The determination region setting unit 503 will be described with reference to FIG. 4A. FIG. 4A is an example setting of the determination area in accordance with the face direction. FIG. 4A illustrates cases for a face directed to the front, an angled direction, and a side direction. A frame 601 surrounded by dotted lines in the figure is the face region determined by face detection. A height 602 of the face region set by face detection is represented as Fh in each face region. The x symbol in the figure represents the center of gravity each face region determined by face detection. A height 604 of the region for determining a lack of face region for a face directed to the front is represented as Ah1. A width 605 of the region for determining a lack of face region for a face directed to the front is represented as Aw1. A height 606 of the region for determining a lack of face region for an angled face is represented as Ah2. A width 607 of the region for determining a lack of face region for an angled face is represented as Aw2. A height 608 of the region for determining a lack of face region for side faces is represented as Ah3. A width 609 of the region for determining a lack of face region for a side face is represented as Aw3.

The setting of the region for determining a lack of face region for each face direction includes setting the height of the region for determining a lack of face region and the width of the region for determining a lack of face region on the basis of the height Fh of the face region set by face detection. In this case, the relationship between the heights of the determination region is Ah1≦Ah2≦Ah3. The height of each determination region is set by a configurable multiplier of the face region height Fh. The relationship between the widths of the determination region is Aw1≦Aw2≦Aw3. The width of each determination region is set by a configurable multiplier of the face region width Fw.

Hereafter, the setting of the region for determining a lack of face region for each face direction according to the present embodiment will be described. According to the present embodiment, the determination region is set wider the higher the degree of side direction of the face. Specifically, when the processing face is directed to the front, the vertical region is set so that the length of Ah1 is twice the Fh, and the center of Ah1 is the center of gravity. The horizontal region is set so that Aw1 is twice the Fh, and the center of Aw1 is the center of gravity. According to the present embodiment, the length of Ah1 and Aw1 are equal, but they may also be different. When the processing face is angled to the right, the vertical region is set so that the length of Ah2 is twice the Fh, and the center of Ah2 is the center of gravity. The horizontal region is set so that Aw2 is three times the Fh, and the center of gravity is the point established by dividing Aw2 into a 1:2 ratio. When the processing face is to the right side, the vertical region is set so that the length of Ah3 is twice the Fh, and the center of Ah3 is the center of gravity. The horizontal region is set so that Aw3 is four times the Fh, and the center of gravity is the point established by dividing Aw3 into a 1:3 ratio. Divisions made when setting the region for determining a lack of face region may be balanced. That is to say, the configurable multiplier of the face region height Fh is not limited to this example.

According to the present embodiment and as previously described, the set region for determining a lack of face region is set so that the margin gradually widens in order from front, angles, and side directions. That is to say, the region is set wider as the degree of side direction increases. This is because the number of features that can be used to identify the region is reduced such as the number of organs (only one eye is detected for side directions), which potentially reduces the accuracy of identifying the region to be image processed for side faces. That is to say, when compared with identifying front face regions, the margin is set larger the side direction when making determinations for side directions in order to prevent side face from being removed in consideration of this reduction of accuracy in identifying face regions for side directions.

FIG. 4A illustrates the case for a left direction, but this is similar for right directions as well. The set region was described as rectangular, but the present invention is not limited thusly. The set region can be other shapes such as elliptical. The processing region was described as using a constant value for the dividing ratio when setting the region, but the present invention is not limited thusly. The processing region can be calculated by the degree of face direction, or it can be set by a previously prepared table. According to the present embodiment, the image processing execution unit 304 executes the automatic layout as the image processing.

FIG. 4B is a block diagram illustrating an example configuration of the image processing execution unit (automatic layout unit). The image processing execution unit 304 performs the automatic layout using the region for determining a lack of face region set by the image analysis region setting unit 303.

The automatic layout unit is provisioned with a template setting unit 701, an image layout unit 702, and a evaluation unit 703.

The template setting unit 701 sets the template specifying the region for setting the image.

The image layout unit 702 sets the image to the set template. The setting of the image to the template is not particularly limited, but according to the present embodiment, images are laid out by a random trimming amount. By randomly setting the trimming amount for one image, the advantage of the automatic layout is further improved by enabling a layout not expected by the user. A predetermined face detection can be performed on multiple images, and the images used in the layout can be randomly set. When main person in the image can be identified by individual recognition, trimming can be performed such that any unnecessary faces of people are not included in the layout region. According to the present embodiment and as previously described, by setting the face region in accordance with the face direction, lack of face region during trimming can be eliminated. When using the face detection result as it is to control trimming, the region for determining a lack of face region including the head cannot be properly set. However, according to the present embodiment, lack of regions including faces can be eliminated by setting the face region in accordance with face direction.

The evaluation unit 703 determines whether or not the region for determining a lack of face region set by the determination region setting unit 503 is included in all regions set for images in the template regarding the layout created by the image layout unit 702. When the region for determining a lack of face region is included in all image regions in the template, it is determined that a lack of face region has not occurred. Conversely, when the region for determining a lack of face region is not included in all image regions in the template, it is determined that a lack of face region has occurred. The determination processing of lack of face region is executed on all faces detected in the image regions, and when there is a determination that a lack of face region has occurred, the image layout is revised, and the evaluation of a lack of face region is performed again. This processing continues until there are no lack of face regions.

The automatic layout unit can also perform other processing such as image compression of the images when creating the image layout.

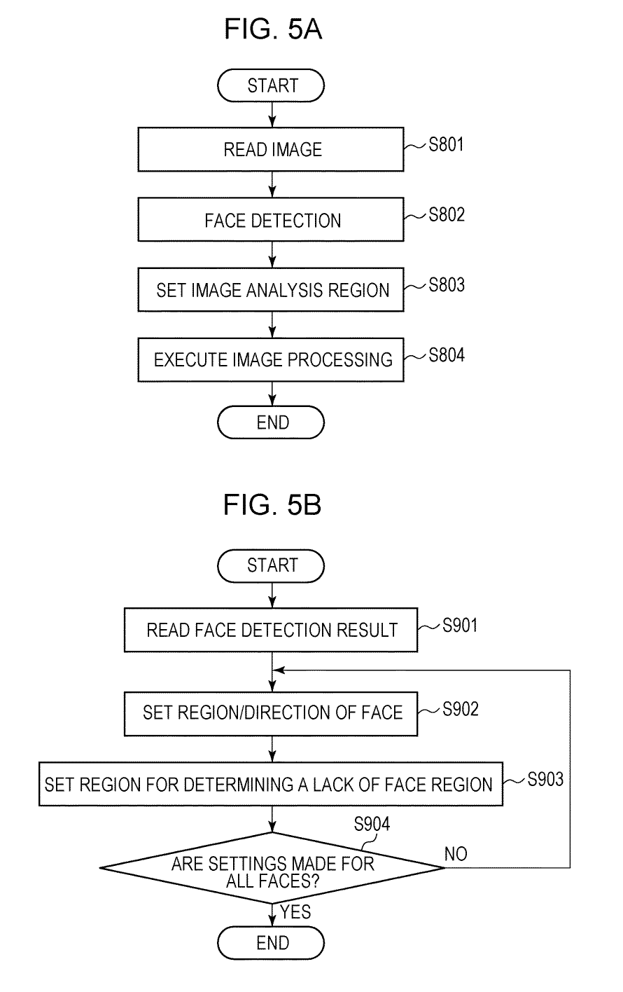

The operation sequence of the image processing unit 202 will be described with reference to FIGS. 5A and 5B. FIG. 5A is a flowchart of the process executed by the image processing unit 202.

First, the processing image is read by the image reader 301 (S801). Next, face detection processing is performed by the face detection unit 302 on the read image (S802). Next, the image analysis region setting unit 303 sets the image processing region in accordance with the detected face direction (S803).

Next, the image processing execution unit 304 executes image processing on the image processing region set by the image analysis region setting unit 303 in accordance with the face direction (S804).

FIG. 5B is a flowchart illustrating an example of the process to set the region for determining a lack of face region in accordance with the face direction.

First, the face detection result reader 501 reads all face detection results detected by the face detection unit 302 (S901). The face detection result includes the face region and face direction of the detected faces.

Next, the face region/direction setting unit 502 sets the face region and direction for one of the read face detection results (S902).

Next, the region for determining a lack of face region setting unit 503 sets the region for determining a lack of face region from the face region and direction set by the face region/direction setting unit 502 (S903).

Next, the face detection result reader 501 determines whether or not the region for determining a lack of face region has been set for all detected faces that have been read, in which case processing ends if this is true. When this is not true, processing returns to S902, and processing is executed on the next face detection result (S904).

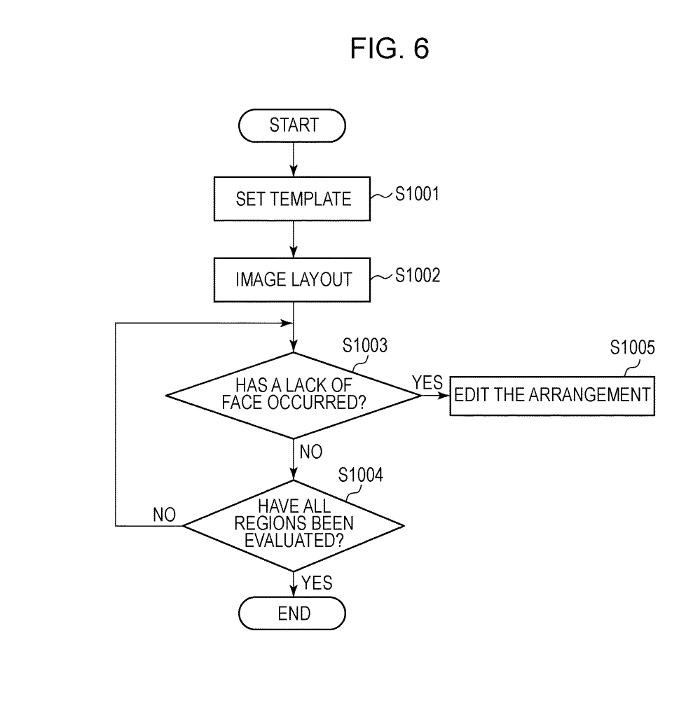

FIG. 6 is a diagram illustrating a process flow for the automatic layout as an example of image processing executed by the image processing execution unit 304.

First, the template setting unit 701 sets the template specifying the regions for setting images (S1001).

Next, the image layout unit 702 sets the image to the set template (S1002).

Next, the evaluation unit 703 evaluates whether or not a lack of face region has occurred in the region for determining a lack of face region set by the region for determining a lack of face region setting unit 503 regarding the layout created by the image layout unit 702 (S1003). When there is a determination that a lack of face region has occurred, the layout is revised (S1005), the processing returns to S1003, and the same processing continues until there are no lack of face region. When there is a determination that a lack of face region has not occurred, a determination is made on whether or not all determinations of the lack of face region have been executed (S1004). If it is determined that evaluations have been made on all region for determining a lack of face regions, the processing ends (S1004). If it is determined that evaluations have not been made on all region for determining a lack of face regions, processing returns to S1003.

According to the present embodiment, the region for image analysis processing, that is to say, the image analysis region is set in accordance with the face direction. According to the present embodiment, by properly setting the region for determining a lack of face region in accordance with the face direction, accurate determination of lack of face region with regard to face regions that change depending on the face direction is possible. As a result, removal of regions including faces can be eliminated, and a preferable layout can be automatically created. Determination of a lack of face region for automatic layout was used as the example for the description, but the present invention is not limited thusly. For example, the face region can be set by a method similar to that of the present embodiment when performing other face region determination processing. Specifically, face region determination processing can be performed, for example, when executing other types of image processing for such issues as overlapping of portions in multiple images, superimposed text, blurred background, and combining backgrounds. Superimposed text processing is processing to obtain an image which has been detected not to include human faces by a face region determination processing as a background image, and then combine text upon the background image. The blurred background processing is processing to determine the degree of focus of the photographer in relation to faces depending on the position, size, and direction of the face regarding a detection result of face regions detected by a face region determination processing, and change the focus of the background. The background combining processing is processing to obtain an image which has been detected not to include human faces by a face region determination processing as a background image, and then combine insertable images such as people or other objects into the background image.

### Second Embodiment

According to the First Embodiment, the face region for image analysis was set in accordance with the face direction, and according to the present embodiment, the region for executing image processing is set in accordance with the face direction. Description of the portions of the configuration that is similar to the First Embodiment will be omitted.

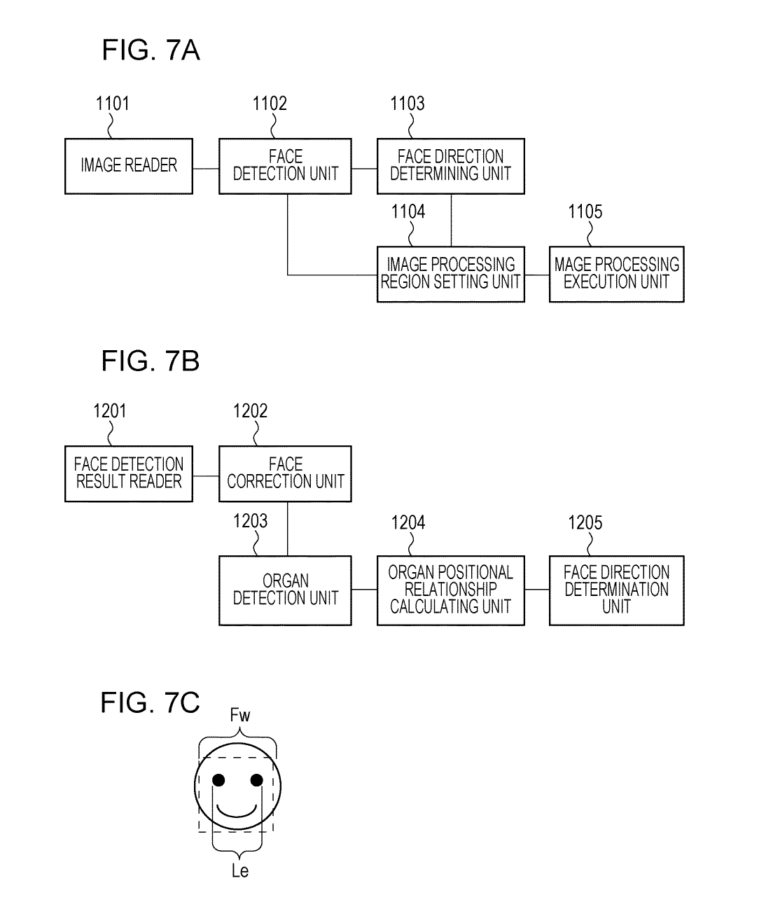

FIG. 7A is a block diagram illustrating an example configuration of the image processing unit according to the present embodiment. According to the present embodiment, the image processing unit performs cosmetic skin correction as the image processing. The cosmetic skin correction performed here will be a smoothing of the face region.

The image processing unit is provisioned with an image reader 1101, a face detection unit 1102, a face direction determining unit 1103, an image processing region setting unit 1104, and an image processing execution unit 1105.

The image reader 1101 loads image data specified by an image file name from the hard disk into RAM. The type of image data is not particularly limited, but in this case will be an RGB image.

The face detection unit 1102 detects objects in the image data loaded to the RAM. The object detection performed in this case is face detection. The object detection process can be similar to the detection process according to the First Embodiment, but in this case, object detection processing in which the face direction cannot be determined during face detection will be performed. According to the present embodiment, detection processing is performed with AdaBoosting without a branched configuration.

The face direction determining unit 1103 determines the face direction of the face region detected by the face detection unit 1102. The face detection unit 1102 will be described with reference to FIG. 7B. FIG. 7B is a block diagram illustrating an example configuration of a face direction determining unit. In this case, processing in which organ detection is performed on the detected face region, and the face direction is determined from the positional relationship between these organs will be described.

The face direction determining unit 1103 is provisioned with a face detection result reader 1201, a face normalization unit 1202, an organ detection unit 1203, an organ positional relationship calculating unit 1204, and a face direction determination unit 1205.

The face detection result reader 1201 reads the face detection result obtained by the face detection unit 1102. The read face detection results in this case are rectangular coordinates of the face region. A case will be described in which a face not rotating on a plane is detected, but the processing region can be set similarly for cases in which the face is rotating on a plane.

The face normalization unit 1202 generates a trimmed image (normalized face image) in which the rotation and size of the face from the detected region that was read and the image data is normalized. First, one face detection result is obtained from all of the read face detection results, and the size and rotation angle of the face detected from this face detection result is calculated. Then, the face region is extracted from the image, and a normalized face image is created by suitably changing the size and rotation angle of the detected face to a predetermined size and angle.

The organ detection unit 1203 detects facial organs from the normalized face image created by the face normalization unit 1202. The detection of the facial organs can use any well-known method. The organs detected are not particularly limited, but in this case, the left eye and the right eye are detected. A correspondence is added to the result of the detected left eye and right eye together with the coordinates of the face detection result and then stored. The organ positional relationship calculating unit 1204 calculates the positional relationship of the organs detected by the organ detection unit 1203. In this case, the distance between the left eye and the right eye is calculated, but the positional relationship between other organs can be used to detect other organs.

The face direction determination unit 1205 calculates the face direction from the distance between the left eye and the right eye calculated by the organ positional relationship calculating unit.

The method to calculate the face direction based on the positional relationship of the organs will be designated with reference to FIG. 7C. FIG. 7C is a diagram illustrating the size after normalization and the distance between the left eye and the right eye. In FIG. 7C, Fw represents the width of the face after normalization, and Le represents the distance between eyes. Le represents the distance between the left eye and the right eye calculated by organ detection. The distance between eyes for front face is almost identical without any individual differences. For this reason, a distance L between eyes after normalization can be previously specified for processing the width of faces after normalization to equal Fw. A face direction (angle) D is determined from the ration between the calculated Le and the specified L.

D=Le/L×90 (Expression 1)

where 0≦Le≦L. Correspondence for the calculated face direction is added to the face detection result and then stored.

In this case, the previously described D represents the degree of face direction. The previously described processing is executed on the detection result for all detected faces.

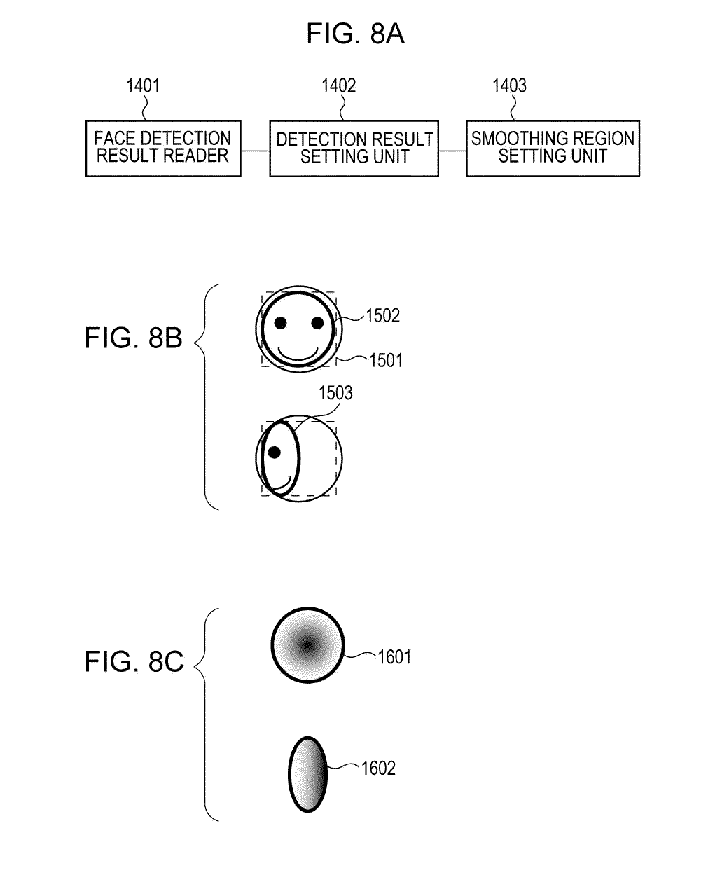

Returning to FIG. 7A, the image processing region setting unit 1104 sets the image processing region in accordance with the face direction determined by the face direction determining unit 1103. The method to set the skin region for executing the cosmetic skin correction will be described with reference to FIG. 8A through 8C.

FIG. 8A is a block diagram illustrating an example configuration of the skin region setting. The image processing region setting unit 1104 (hereinafter, also referred to as the skin region setting unit) is provisioned with a face detection result reader 1401, a detection result setting unit 1402, and a smoothing region setting unit 1403.

The face detection result reader 1401 reads all face detection results detected by the face detection unit 1102. The face detection results, which include the face region detected by the face detection unit 1102, the organ positions detected by the organ detection unit 1203, and the face direction calculated by the face direction determining unit 1103, are read.

The detection result setting unit 1402 sets one face detection result from all the face detection results read by the face detection result reader 1401. The detected face region, organ positions, and face direction are set.

The smoothing region setting unit 1403 sets the region for executing cosmetic skin correction in accordance with the face region and face direction set by the detection result setting unit 1402.

The setting of the smoothing region will be described with reference to FIG. 8B. FIG. 8B is a block diagram of the smoothing region setting unit 1403. According to the present embodiment, the setting of the smoothing region creates more narrow regions as the degree of side direction increases. The form of the smoothing region is set (changed) in accordance with the face direction. The smoothing region is circular for front face, for example, which gradually becomes an acute ellipse as the direction changes to a side face. Setting of the elliptical region may use any well-known ellipse equation.

x̂2/â2+ŷ2/b̂2=1 (Expression 2)

where x represents the horizontal axis, and y represents the vertical axis. Regarding one-half of the length of the long axis of the ellipse (major axis) and one-half of the length of the short axis (short axis), a corresponds to x and b corresponds to y. a and b are determined from the size of the detected face.

FIG. 8B is a diagram describing the setting of the smoothing region. In FIG. 8B, a frame 1501 surrounded by dotted lines represents the region during face detection. A smoothing region 1502 for front faces is set as a circle inscribing the region of the face detection result, as the Expression 2 results in a=b. A smoothing region 1503 for side faces is set as an elliptical region. In this case, the center of the ellipse changes depending on the organ position, for example. According to the present embodiment, the position of the ellipse is determined on the basis of the eye positions.

First, the ellipse is set. An elliptical radius a is calculated in accordance with the face direction determined by the face direction determination unit 1205.

a=r×D/90 (Expression 3)

where r represents the radius of the circle inscribing the face detection result.

Next, the position to set the calculated ellipse is calculated. If the center coordinates of the detected face region is designated as (Fx, Fy), the center coordinates of the ellipse is set as (Fx−a, Fy).

If the face region is near the edge of the processing image, the previously described processing region (smoothing region in this case) is set so as not to protrude from the processing image.

According to the present embodiment, the level of correction is set internally to the smoothing region. In this case, the level of correction is set in accordance with the face direction.

FIG. 8C is a diagram illustrating the distribution of correction levels with regard to the face direction. 1601 represents the distribution of correction levels set corresponding to the smoothing region for faces directed to the front. As illustrated in the figure, the level of correction has a gradient such that the amount of correction is set larger as the dark areas become blacker, and the correction amount is set smaller as this gradient becomes whiter. 1602 represents the distribution of correction levels set corresponding to the smoothing region for faces turned to the left. The amount of correction is set to gradually increase in the direction toward the head.

According to the present embodiment and as previously described, by setting the processing region narrower as the degree of side direction increases when performing smoothing processing, the smoothing processing can be performed on a suitable region.

Returning to FIG. 7, the image processing execution unit 1105 executes the image processing on the image processing region set by the image processing region setting unit 1104. According to the present embodiment, the cosmetic skin correction is executed on the set cosmetic skin correction region.

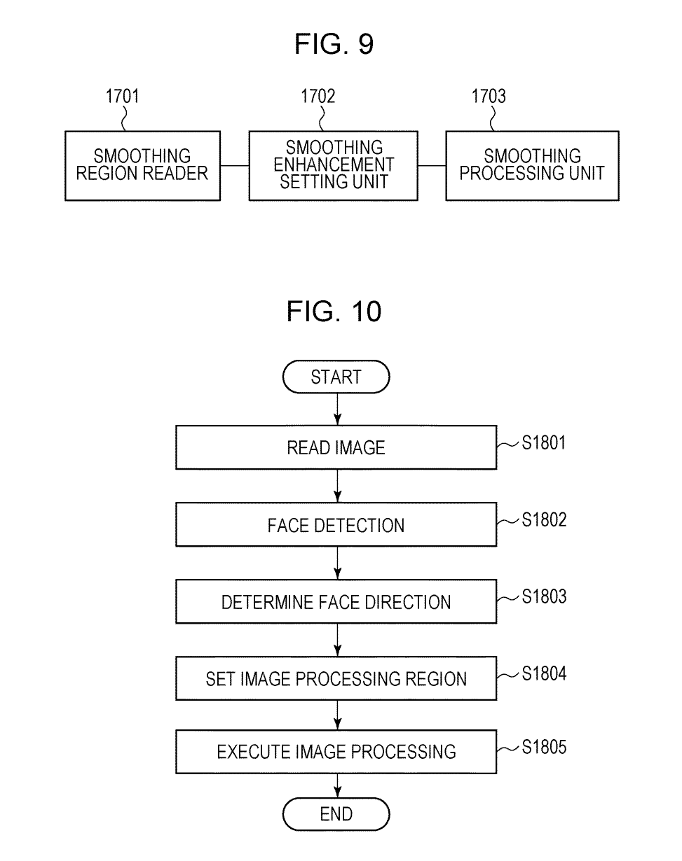

FIG. 9 is a block diagram illustrating an example configuration of the image processing execution unit 1105 (hereinafter, also referred to as the cosmetic skin correction processing unit). The image processing execution unit 1105 is provisioned with a smoothing region reader 1701, a smoothing level setting unit 1702, and a smoothing processing unit 1703.

The smoothing region reader 1701 reads the smoothing region set by the smoothing region setting unit 1403.

The smoothing level setting unit 1702 sets the level of smoothing. The level of smoothing can be set by the user, for example. Specifically, a special application for performing cosmetic skin correction is displayed on the display 104, which can be set by user operation. Processing level setting parameters are provisioned to the special application for performing cosmetic skin correction, and the level of correction can be set by using the input device 105 such as a mouse or keyboard.

The smoothing processing unit 1703 performs the smoothing processing on the set smoothing region. The smoothing processing can use any well-known method, but according to the present embodiment, smoothing processing is performed by filter processing. The setting level in this case is set from the level set by the smoothing level setting unit 1702 and the amount of correction included in the region set by the smoothing region setting unit 1403. The filter size during smoothing is set by the level set by the smoothing level setting unit 1702, and the level distribution included during the smoothing region setting is set as the blend ratio between the smoothing image and the original image. By compositing the smoothing image and the original image in accordance with the amount of correction, image degradation at the boundaries of the correction region can be reduced, which improves image quality.

FIG. 10 is a process flow for executed by the image processing unit according to the present embodiment.

First, the processing image is read by the image reader 1101 (S1801).

Next, face detection processing is performed by the face detecting unit 1102 on the read image (S1802). Next the face direction determining unit 1103 determines the face direction from the detected face region (S1803).

Next, the image processing region setting unit 1104 sets the image processing region in accordance with the face direction determined by the face direction determining unit 1103. According to the present embodiment, the skin smoothing region is set (S1804).

Next, the image processing execution unit 1105 executes the skin processing by performing the smoothing processing on the region set by the image processing region setting unit 1104 (S1805).

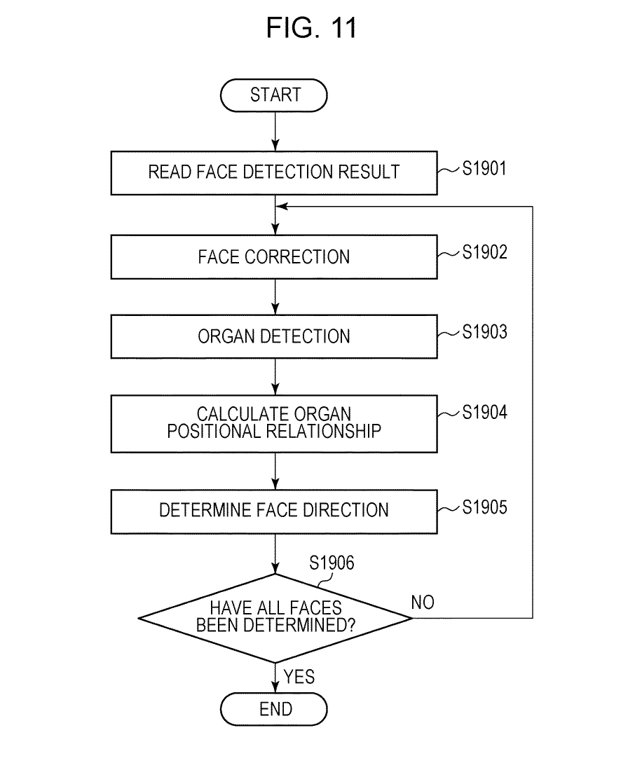

The processing executed by the face direction determining unit 1103 will be described with reference to FIG. 11. FIG. 11 is a diagram illustrating the process flow executed by the face direction determining unit 1103.

First, the face detection result reader 1201 reads all face detection results detected by the face detecting unit 1102 (S1901).

Next the face normalization unit 1202 generates a trimmed image (normalized face image) in which the rotation and size of the face from the detected region that was read and the image data is normalized (S1902).

Next, the organ detection unit 1203 detects facial organs from the normalized face image created by the face normalization unit 1202. In this case, the left eye and the right eye are detected by organ detection (S1903).

Next, the organ positional relationship calculating unit 1204 calculates the positional relationship of the organs detected by the organ detection unit 1203. In this case, the distance between the left eye and right eye are calculated (S1904).

Next, the face direction determination unit 1205 calculates the face direction from the distance between the left eye and the right eye calculated by the organ positional relationship calculating unit 1204 (S1905).

Next, a determination is made on whether or not the face determination has been executed on all detected faces (S1906). If it is determined that face direction determinations have not been made on all faces, processing returns to S1902. Conversely, if it is determined that face direction determinations have been made on all faces, processing stops. In this way, the processing continues until face direction determinations have been made for all detected faces.

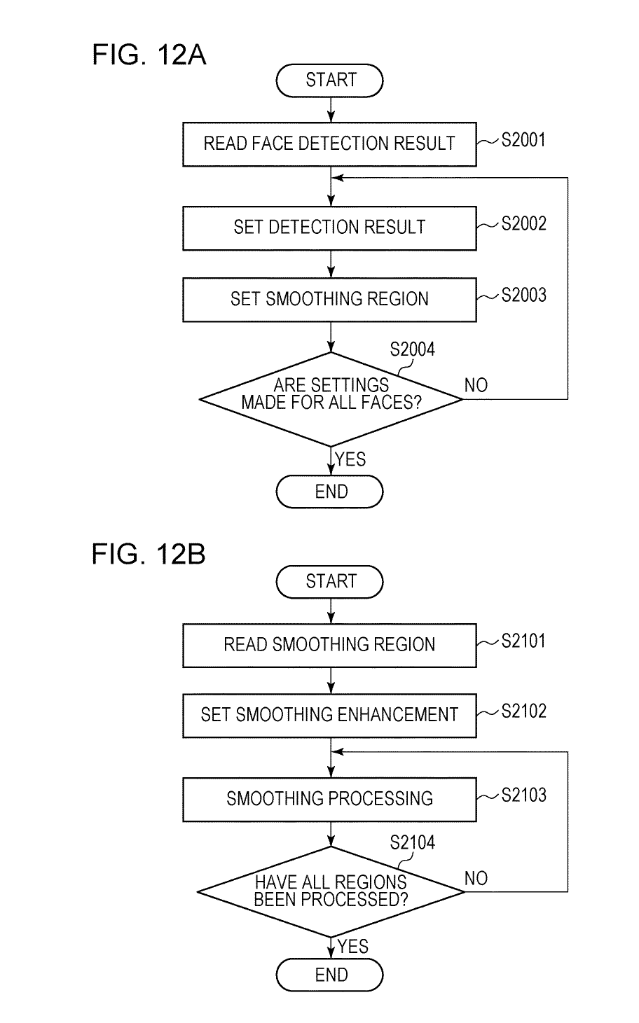

The process executed by the skin region setting unit will be described with reference to FIG. 12A. FIG. 12A is a diagram illustrating the process flow executed by the skin region setting unit.

First, the face detection result reader 1401 reads all face regions detected by the face detecting unit 1102 (S2001).

Next, the detection result setting unit 1402 sets one face detection result from all the face detection results set by the face detection result reader 1401.

Next, the smoothing region setting unit 1403 sets the region for executing cosmetic skin correction in accordance with the face region and face direction set by the detection result setting unit 1402 (S2003).

Then, a determination is made on whether or not the smoothing region setting has been executed on all detected faces (S2004). If it is determined that smoothing region settings have not been made on all faces, processing returns to S2002. Conversely, if it is determined that smoothing region settings have been made on all faces, processing stops. In this way, the processing continues until smoothing region settings have been made for all detected faces.

FIG. 12B is an example of a detailed flowchart of the cosmetic skin correction processing.

First, the smoothing region reader 1701 reads the smoothing region set by the smoothing region setting unit 1403 (S2101).

Next, the smoothing level setting unit 1702 sets the level of smoothing (S2102).

Next, the smoothing processing unit 1703 performs the smoothing processing on the set smoothing region (S2103).

Then, a determination is made on whether or not the smoothing processing (cosmetic skin correction processing) has been executed on all detected faces (S2104). If it is determined that smoothing processing has not been made on all faces, processing returns to S2103. Conversely, if it is determined that smoothing processing has been made on all faces, processing stops. In this way, the processing continues until smoothing processing has been made for all detected faces.

According to the present embodiment, by setting the cosmetic skin correction region in accordance with the calculated face direction, preferable correction can be performed while reducing correction errors outside the face region. Specifically, the correction region is gradually set narrower as the degree of side direction increases. This is because the number of features that can be used to identify the region is reduced such as the number of organs, which potentially reduces the accuracy of identifying the region to be image processed for side faces. That is to say, when compared with identifying front face regions, image processing is performed on the region more accurately identified as the face (in this case, the skin) in consideration of this reduction of accuracy in identifying face regions for side directions.

By controlling the pattern of the correction level in accordance with the face direction when setting the correction region, a more preferable correction can be performed.

According to the present embodiment, cosmetic skin correction was described as the example of smoothing processing performed on the face region, but the image processing is not limited thusly. For example, the face region may be set by a method similar to that of the present embodiment when performing other correction processing. For example, correction processing can be performed on the face region such as face brightness correction to brighten the face region, face sharpness correction, which is a processing to enhance the edges of the face region, and so on. In addition, correction processing on the face region can also include size reduction correction to reduce the size of the face region. The correction processing on the face region can also include contour correction to correct the contour of the face. Additionally, correction processing in these cases refers to processing to change images, for example. According to the present embodiment, the image processing region can be set with regard to the face direction as the face direction can be determined by performing organ detection even when the user specifies the face region via manual input. According to the present embodiment, the organ detection is performed by the organ detection unit 1203, but the user can also specify and input the positions of organs.

### Third Embodiment

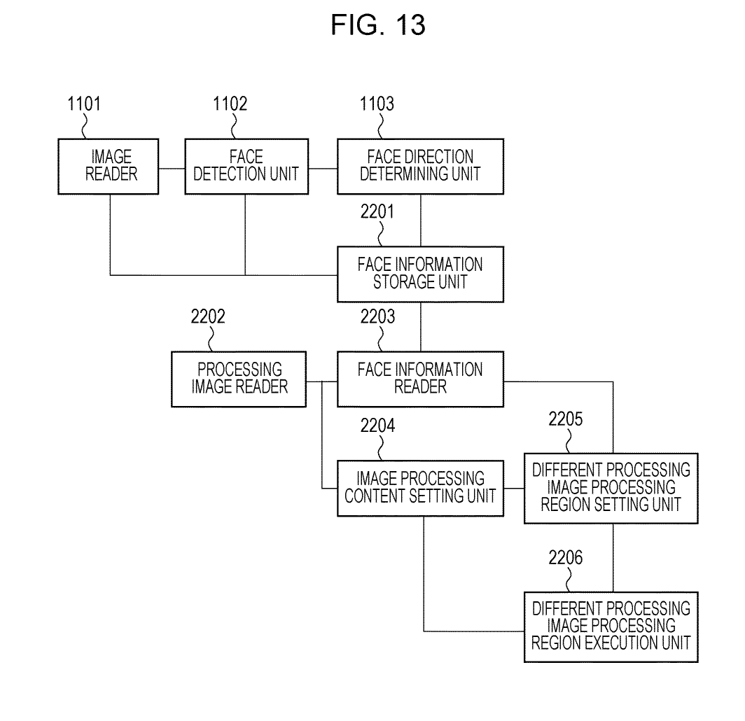

According to the present embodiment, face information including the face region and face direction is stored in a database, the face information is read from the database when executing image processing, the image processing region is set, and image processing is executed. Description of the portions of the configuration that is similar to the First Embodiment and Second Embodiment will be omitted. FIG. 13 is a block diagram illustrating an example configuration of the image processing unit according to the present embodiment.

The image processing unit according to the present embodiment is provisioned with the image reader 1101, the face detection unit 1102, and the face direction determining unit 1103. The image processing unit is additionally provisioned with a face information storage unit 2201, a processing image reader 2202, a face information reader 2203, an image processing content setting unit 2204, a different processing image processing region setting unit 2205, and a different image processing image processing region execution unit 2206. Portions of the configuration with the same reference numerals as that for the First Embodiment and the Second Embodiment have the same functions, and so their description will be omitted.

The face information storage unit 2201 adds a correspondence of the face position detected by the face detection unit 1102 with the image file name specified when the face direction determined by the face direction determining unit 1103 is input and the image is read by the image reader 1101, and saves this as the face information. This is executed for all images for analyzing face information.

The processing image reader 2202 reads the image specified by the file name.

The face information reader 2203 reads the face information stored by the face information storage unit 2201 on the basis of the image file name specified by the processing image reader 2202. The face information includes face positional information and face direction.

The image processing content setting unit 2204 sets the image processing content to be executed on the image specified by the processing image reader 2202. According to the present embodiment, image processing content such as automatic layout and cosmetic skin correction are set. The setting of the image processing content can be set on the basis of user operation. When executing image processing by a special image processing application, a screen is provisioned to enable the selection of the image processing to be executed on the specified image by the user.

The different processing image processing region setting unit 2205 sets the image processing region in accordance with the image processing content specified by the image processing content setting unit 2204 on the basis of the face information read from the face information reader 2203. When automatic layout is performed using the specified image, the region for determining a lack of face region is set on the basis of the face information. When performing cosmetic skin correction, the skin region is set on the basis of the face information. The image processing region is set in accordance with the image processing content and the face direction.

The different image processing image processing region execution unit 2206 executes the processing set by the image processing content setting unit 2204 on the image processing region set by the different processing image processing region setting unit 2205.

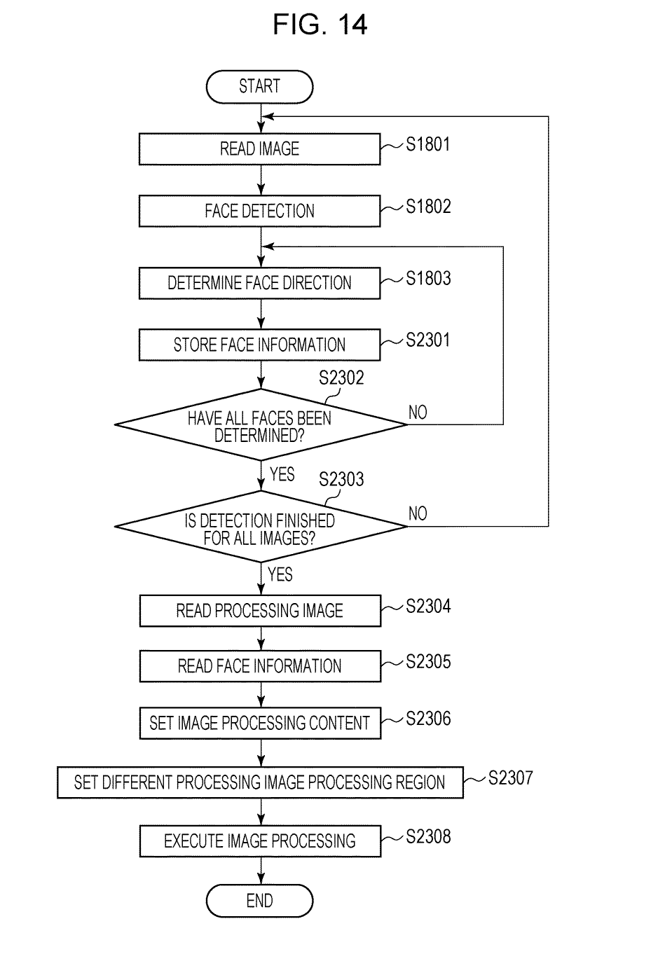

FIG. 14 is a process flow for executed by the image processing unit according to the present embodiment. Face information including the face region and face direction is stored in a database, the face information is read from the database when executing image processing is used to set the image processing region, and execute the image processing.

First, the image reader 1101 reads the image specified by the image file name (S1801).

Next, face detection processing is performed by the face detecting unit 1102 on the read image, and the face region is obtained (S1802).

Next the face direction determining unit 1103 determines the face direction from the detected face region (S1803).

Next, the face information storage unit 2201 adds a correspondence of the face direction determined by the face direction determining unit 1103 and the face region detected by the face detection unit 1102 with the image file name, and saves this (S2301).

A determination is made on whether or not S1803 and S2301 were performed on all detected faces (S2302). A determination is also made on whether or not the processing to register the face information corresponding to all previously read file names to the database has been performed. If this is not yet complete, the same processing continues for the remaining image files (S2303).

Next, the processing image reader 2202 reads the image specified by the image file name (S2304).

Next, the face information reader 2203 reads the face information stored by the face information storage unit 2201 on the basis of the image file name specified by the processing image reader 2202 (S2305).

Next, the image processing content setting unit 2204 sets the image processing content on the image specified by the processing image reader 2202 (S2306).

Next, the different processing image processing region setting unit 2205 sets the image processing region in accordance with the image processing content specified by the image processing content setting unit 2204 on the basis of the face information read from the face information reader 2203 (S2307).

Lastly, the different image processing image processing region execution unit 2206 executes the processing set by the image processing content setting unit 2204 on the image processing region set by the processing image processing region setting unit 2205 (S2308).

According to the present embodiment, the image processing region is set, and image processing is executed on the image processing region by using the face information previously stored in the database when executing image processing. In this way, the image processing region can be set in accordance with the image processing content by the exchange of face regions with the database. That is to say, by setting the image processing region in accordance with the image processing content on the basis of the face region and direction stored in the database, the appropriate face detection can be switched for each image processing, that is to say, the efficiency of the processing system can be improved by not requiring face detection to be performed for every image processing. The face information is constant regardless of the content of image processing, and so the amount data stored in the database can be reduced as well as the processing required needed to determine the face detection and face direction.

### OTHER EMBODIMENTS

According to the previously described embodiments, the processing region for executing image processing can be appropriately set in accordance with the face direction, and a high quality image processing result can therefore be obtained.

The basic configurations of the present invention are not limited to the previously described embodiments. The previously described embodiments are one method for obtaining the advantages of the present invention. Using similar but different methods and different parameters is within the scope of the present invention as long as equivalent advantages of the present invention are obtained. For example, the processing region is not limited to either a circle or rectangle, and can also have other shapes such as a triangle.

The previously described embodiments described the image processing apparatus as a computer, but the present invention is not limited thusly. For example, the present invention may be applied to various devices that perform image processing such as printers, copiers, fax machines, cell phones, PDAs, image viewers, and digital cameras.

The present invention can be applied to a system configured from multiple devices (for example, a host computer, interface devices, readers, printers, etc.), and it can also be applied to an apparatus made from one device (for example, printers, copiers, fax machines, etc.).

The previously described embodiments may be implemented by executed the following processing. That is to say, software (program) implementing the functions of the previously described embodiments is supplied to a system or device via a network or various types of storage media. A computer (CPU or MPU) in the system or device reads and executes the program. The program can be executed by one computer, or it can be executed by linking multiple computers. All of the previously described processing does not have to be implemented as software, and so a portion or all of this processing can be implemented as hardware.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-137044, filed Jun. 28, 2013, which is hereby incorporated by reference herein in its entirety.

What is claimed is:

1. An apparatus comprising:
an obtaining unit configured to obtain information representing a face direction in a face region of an image that includes a face;
a setting unit configured to set a processing region for executing imaging processing on the image based on the information representing the face direction obtained by the obtaining unit; and
an image processing unit configured to perform image processing on the processing region set by the setting unit.

2. The apparatus according to claim 1,
wherein the setting unit sets the processing region based on a size of the face region.

3. The apparatus according to claim 1, further comprising a determination unit configured to determine the face direction in the face region of the image,
wherein the determination unit classifies face direction into at least two different face directions.

4. The apparatus according to claim 1, further comprising a detection unit configured to detect the face region from the image.

5. The apparatus according to claim 4,
wherein the detection unit detects the face region and determines the face direction in the face region.

6. The apparatus according to claim 1,
wherein the setting unit changes at least one of a processing region size and a processing region shape in accordance with the face direction.

7. The apparatus according to claim 1,
wherein, if the image processing performed on the image is analysis processing, the setting unit gradually sets a narrower region as a degree that the face is directed to a side becomes higher.

8. The apparatus according to claim 1,
wherein, if the image processing performed on the image is region determination processing, the setting unit gradually sets a wider region as a degree that the face is directed to a side becomes higher.

9. The apparatus according to claim 1,
wherein, if the image processing performed on the image is correction processing, the setting unit gradually sets a narrower region as a degree that the face is directed to a side becomes higher.

10. A method for an apparatus, the method comprising:
obtaining information representing a face direction in a face region of an image that includes a face;
setting a processing region for executing imaging processing on the image based on the information representing the obtained face direction; and
performing image processing on the set processing region.

11. A non-transitory computer readable recording medium storing a program to cause a computer to execute a method the method comprising:
obtaining information representing a face direction in a face region of an image that includes a face;
setting a processing region for executing imaging processing on the image based on the information representing the obtained face direction; and
performing image processing on the set processing region.
